(19) United States
(12) Patent Application Publication
(10) Pub. No.: US 2007/0090182 A1
(43) Pub. Date: Apr. 26, 2007

(54) All-In-One card and its management

(76) Inventors: Vijay Singh Phagura, Mountain View, CA (US); Anita Phagura, Mountain View, CA (US)

Correspondence Address: Vijay S. Phagura, PO Box 548, Mountain View, CA, 94042, US

(21) Appl. No.: 11/256,746

(22) Filed: Oct. 24, 2005

(51) Int. Cl. G06K 5/00; G06K 19/06

(52) U.S. Cl. 235/380; 235/492

(57) ABSTRACT

The All-In-One card, referred to as AIOC in this document, is a smart card which contains multiple credit cards, debit cards and other applications for the user. For instance, it may contain an application which offers various pre-programmed credit cards to the user to choose from, to pay for a purchase. This patent solves the problem, through software, of: Adding/removing multiple credit or debit cards in/from AIOC. Managing multiple applications on AIOC. Sharing data between applications on the AIOC, securely. User interaction with the AIOC. Transaction processing from the AIOC and to the merchants.

### BACKGROUND

There are so many credit and debit cards these days and users have to carry a bundle of these cards all over the places in the wallets. These cards are easily lost and are prone to fraud. Also, they are hard to keep track of physically. The All-In-One Card (AIOC) will allow users to consolidate all cards into one, still giving them a choice to pay from any particular card for a transaction. All the credit or debit cards can be stored electronically, referred to as e-cards in this document, on one AIOC.

Advantages of AIOC are as follows:
Users have to carry only one card
AIOC is a Smart Card which is more secure than the regular magnetic strip cards. New generations of these cards will have biometrics built into them so they can be closely associated with an individual.
AIOC can have multiple applications programmed either at the time of issue or later.
These cards can also provide secured internet access.
Can also carry e-money
Card applications can be easily hooked to PC applications

These cards can perform any transaction through a card reader hooked to a PC via an USB port or through a cell phone. There are also standalone readers available for these cards which can be purchased by venders, where these cards can be used.

The AIOC is more secure than the conventional cards and have fewer chances to be fraudulent. Banks lose a lot of money each year in credit/debit card frauds; AIOC can reduce these losses to banks. AIOC can store any credit cards and bank cards as e-cards.

Currently, when the user pays for a transaction the following happens:

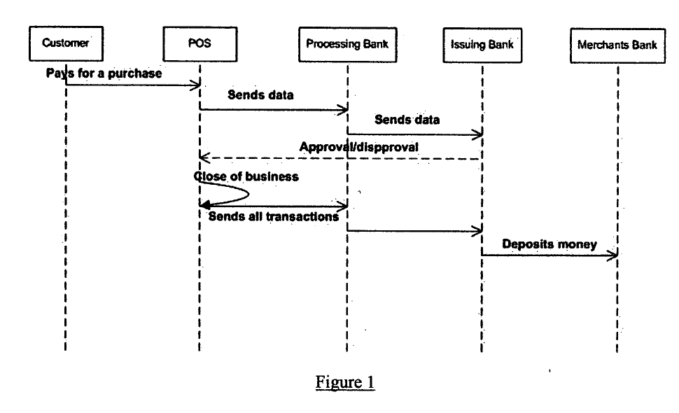

As seen from the FIG. 1, it all begins from the point when the user swipes the card or enters their account details while paying or withdrawing, at the point-of-sale (POS). The POS dials into the processing organization for authorization. The processing organization or bank translates the information and sends it to the issuing bank that issued the card to the user. The issuing bank verifies the validity of the account and the limit on the account and sends an approval or disapproval to the processing bank to complete a transaction. The completed transactions are stored in the POS until the business closes and then are ‘batched out’ or sent to the processing bank for transferring funds to the business's or merchant's bank.

None of the above back-end working is going to change with the use of AIOC, except how the user selects an e-card to pay.

### SUMMARY

This invention is a smart card based AIOC which interacts with software to solve the following problems:
Adding/removing multiple credit cards in/from AIOC.
Managing multiple applications on AIOC.
Sharing data between applications on the AIOC, securely.
User interaction with the AIOC.
Transaction processing from the AIOC and merchants to the financial institutes.

### DETAILS

There would be three main categories of software used to interact with this card:
1. Issuance software: This type of software will be used by the AIOC card issuance companies to manage their customers and cards. Using this software the issuance company can also put various applications on the cards. It may include the software for managing the card usage etc.
2. End-user software: This category of software would be responsible for helping the card owners to manage their accounts for different e-cards and other applications on this AIOC.
3. Card software: This category would be the software on the AIOC itself to serve the users.

Please note that any of these categories may contain multiple pieces of software, standalone or internet based.

User interaction with the card can be via a computer, cell phones or a standalone reader.

Issuance Software

As stated earlier, this software is used by Issuance Company or bank of an AIOC. This software can be an internet based application which interacts with other software at this company or a bank. This software can have various functions like read statistics about an AIOC provide upgrades or newer card applications, etc.

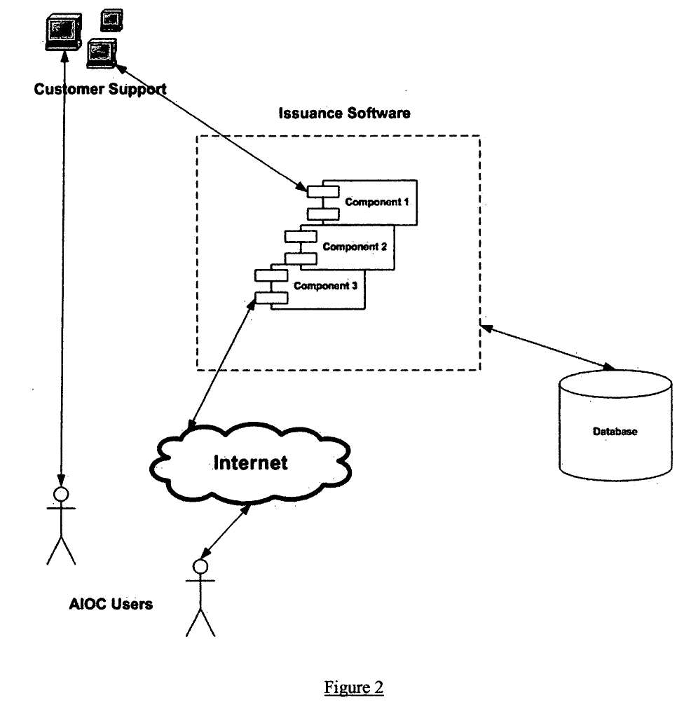

This software registers the AIOC card whenever an end user logs on to their AIOC account with their card connected. It reads the statistics from the card. It also prompts the user to load newer applications or any upgrades, if available. A higher level architecture of this software is as shown in FIG. 2.

This software will have a database with records of all AIOC cards and users. The database will have a table that will contain entries for available upgrades of existing applications or newer applications that could be downloaded on a given user's card. This table will be updated up the issuance company, through software. Please note that the design and implementation is not limited to the proposal presented here.

End-User Software

This software may be designed in two parts. One part would be hosted on the users terminal (this could be a PC, a cell phone or a PDA), which may include smart card reader drivers and utilities. The other part would be at the issuance company available to the users via the internet to maintain their accounts. The software on the user's terminal becomes the mediator between the AIOC and the issuance company for the transfer of either the account information or software upgrades. The AIOC will communicate with the software on the user's terminal using a standard Smart Card protocol. The software on the user's terminal will communicate with the software at the issuance company through a specific protocol. All the information going back and forth will be encorypted for security.

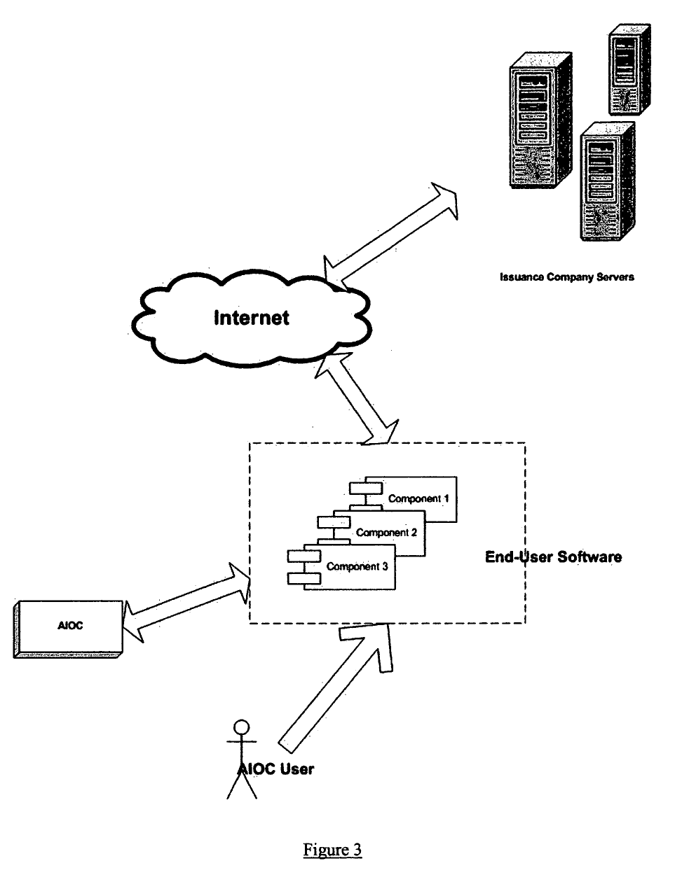

FIG. 3 shows a high level general architecture of this part of the software. It also shows how the pieces fit together in a bigger picture with the issuance company software.

The user can also add or remove credit cards from their AIOC. The process of adding a credit card can be done by the user by selecting a utility from the issuance company's software over the internet by providing the details of the credit card. Depending on the issuance company's policy, this can be approved immediately or the company would run some rules on it to determine other facts about this card.

The issuance company software part can also give the user other information which they may desire on all the applications on their AIOC. For instance, if they have a Miles program application on their AIOC, they could know how many miles they have accumulated etc. Apart from getting this sort of information after logging on to the internet, the card user can also get this type of information from the card terminal they use for a transaction.

Card Software

This is the software on the AIOC. This can include, but not limited to:
Card operating system
Card drivers
Card applications

This patent's covers the Card Applications. The AIOC application will be loaded on the card, as one of the applications, at the time of issue by the card issuance company. This would be the main application to perform the following functions:
Perform transactions in an ACID format
Present all available payment options to the user
Add cards on AIOC on users request
Communicate with the issuance company's software after the user logs on to their account.
Perform security functions
Perform house keeping
Provide easeful upgrade

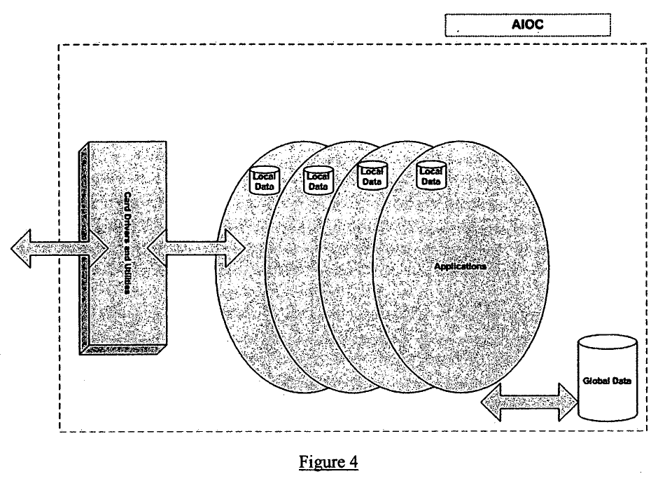

The AIOC will have a design outline in FIG. 4.

As shown in the FIG. 4, the application will have a small database that will hold all the sharable data for the various components of the card application. There will be a global data outside the card application to be shared by other applications on the card.

An important aspect of the AIOC in terms of data storage is that it will not keep or store lots of historic data, due to resource constraints. All the historic and important data will be with the issuance company but could be made available to the user for viewing.

Transaction by an AIOC User

The transaction will start as soon as the user selects a card for paying for a purchase. The card selection can be done by various means as follows, but not limited to:
1. Using a Cell phone or a PDA
2. AIOC readers at POS
3. Computer with appropriate software

The AIOC card application can be mounted on a cell phone SIM card or on some other media of the future. On the cell phone from an ‘Application Menu’ the user selects the AIOC card application. This in turn will present the users a choice to pick a card from the available cards on this AIOC. After the user chooses a card, the card application will start the verification process by verifying some information from the user like password or pin, the amount to pay for the purchase etc. The user will be asked to provide the POS number or the business's account number. As soon as the user agrees to the payment agreement the transaction starts.

The processing after this point on can be done in two ways:
The transaction appears on the merchants POS terminal and they would further proceed with the transaction, like a regular transaction as detailed in FIG. 1. The result of the transaction is sent to the POS.
The transaction goes as a regular transaction to the processing organization as detailed in FIG. 1. The result is posted to the merchant's account and the user's cell phone or computer etc. The merchant can check on this transaction in real-time.

The merchant and the user can see the transaction results. This way the whole process forms a closed loop. All the history of transactions for a user will go to their AIOC account at the AIOC issuing bank.

Security Aspects of AIOC

As mentioned, the AIOC will be secured as it is a Smart Card which uses industry standards for security. The newer technologies of Smart Card will be able to provide AIOC with more advanced security like biometrics.

Security comes into picture as soon as a user is ready to start a transaction for a purchase. The user would be authenticated and then authorized according to the access role assigned by the AIOC issuance company. All card access devices like cell phones, PDA, computer etc, will provide an interface to the user via the card software. The user will be allowed to access a resource on the card only after being validated by the card and then the issuance company (also, by their e-card issuance bank, if needed).

There are multiple tiers of security:
1. On card credential validation: This is done using the user provided the PIN or user id and password or biometrics
2. AIOC Issuance Company validation: This happens after the card validation succeeds. The AIOC Issuance Company will authorize the AIOC to be used based on the user credentials.
3. Card application authorization: If the user uses the card application, they can choose any e-card from the available e-cards on the AIOC to make a payment. The issuance bank of this selected e-card has to authorize the payment. If the user uses any another application that lets him use his e-cards on the AIOC then that application has to authorize the user to proceed.

1. An All-In-One (AIOC) card is a Smart Card comprising of multiple credit and debit cards, the AIOC card software and other applications.

2. The AIOC of claim 1 wherein: the card is managed and controlled by Issuance Company via software that can communicate with the card software using a protocol.

3. The AIOC of claim 1 wherein: the card can be accessed and managed by the card owner, via software on the owner's terminal.

4. The AIOC of claim 3 wherein: the software allows the owner to add or remove credit and debit cards and other applications to or from the AIOC.

5. The AIOC of claim 1 wherein: the card software will allow the owner to select a card from the AIOC for a transaction.

6. The AIOC of claim 1 wherein: the card software will allow the owner to switch between different applications.

7. The AIOC of claim 3 wherein: the owner's terminal can be different input devices like PDA, PC, Cell phones etc.

8. The AIOC of claim 5 wherein: the transactions will be highly secured using encryption and/or biometrics.

9. The AIOC of claim 1, 2 and 3 wherein: the card's, issuance company's and the owner's software will provide multiple tiers of security.

10. The AIOC of claim 1 wherein: the card software will provide secured data sharing between all applications on the AIOC.

11. The AIOC of claim 5 wherein: the AIOC transaction will be similar to that of a conventional card transaction processing.

12. The AIOC of claim 1 wherein: the card will have a database for all its applications.

13. The AIOC of claim 1 and 12 wherein: the card software and the database will support ‘Data Anywhere’ concept, so that the current data can be accessed anywhere from the card, without connecting to the issuance company network.

14. The AIOC of claim 1 wherein: the card software will be hardware and vender independent.

15. The AIOC of claim 1, 2 and 3 wherein: the software will communicate with various databases.
